(19) United States
(12) Patent Application Publication
(10) Pub. No.: US 2025/0363615 A1
(43) Pub. Date: Nov. 27, 2025

(54) IMAGE RECONSTRUCTION VIA MANIFOLD LEARNING

(71) Applicant: KLA Corporation, Milpitas, CA (US)

(72) Inventors: Laurent Karsenti, Rehovot (IL); Ankit Rai, Bengaluru (IN); Rajasekhar Kuppa, Morgan Hill, CA (US); Rotem Littman, Hod Hasharon (IL); Dror Sharf, Ramat Gan (IL)

(21) Appl. No.: 19/063,200

(22) Filed: Feb. 25, 2025

Related U.S. Application Data
(60) Provisional application No. 63/669,691, filed on Jul. 11, 2024.

(30) Foreign Application Priority Data
May 27, 2024 (IN) 202441040888

(51) Int. Cl. G06T 7/00; G06T 7/80; G06V 10/24; G06V 10/77; G06V 10/774; G06V 10/776; G06V 10/98

(52) U.S. Cl. CPC G06T 7/0006; G06T 7/80; G06V 10/245; G06V 10/7715; G06V 10/774; G06V 10/776; G06V 10/98; G06T 2207/20081; G06T 2207/20084; G06T 2207/30148; G06V 2201/06

(57) ABSTRACT

Methods and systems for image reconstruction are provided. One system includes a computer system configured for separating an image generated for a semiconductor-related specimen into patch images smaller than the image. The system also includes a neural network configured for projecting at least one of the patch images to a manifold that includes feature vectors learned from training images whose image quality meets or exceeds predetermined criteria. The neural network also reconstructs the patch image from the feature vectors it aligns to on the manifold thereby generating a reconstructed patch image having one or more image qualities better than the input patch image.

### BACKGROUND OF THE INVENTION

### 1. Field of the Invention

The present invention generally relates to methods and systems for image reconstruction. Certain embodiments relate to image reconstruction via manifold learning.

### 2. Description of the Related Art

The following description and examples are not admitted to be prior art by virtue of their inclusion in this section.

Fabricating semiconductor devices such as logic and memory devices typically includes processing a substrate such as a semiconductor wafer using a large number of semiconductor fabrication processes to form various features and multiple levels of the semiconductor devices. For example, lithography is a semiconductor fabrication process that involves transferring a pattern from a reticle to a resist arranged on a semiconductor wafer. Additional examples of semiconductor fabrication processes include, but are not limited to, chemical-mechanical polishing (CMP), etch, deposition, and ion implantation. Multiple semiconductor devices may be fabricated in an arrangement on a single semiconductor wafer and then separated into individual semiconductor devices.

Inspection processes are used at various steps during a semiconductor manufacturing process to detect defects on specimens to drive higher yield in the manufacturing process and thus higher profits. Inspection has always been an important part of fabricating semiconductor devices. However, as the dimensions of semiconductor devices decrease, inspection becomes even more important to the successful manufacture of acceptable semiconductor devices because smaller defects can cause the devices to fail.

Defect review typically involves re-detecting defects detected as such by an inspection process and generating additional information about the defects at a higher resolution using either a high magnification optical system or a scanning electron microscope (SEM). Defect review is therefore performed at discrete locations on specimens where defects have been detected by inspection. The higher resolution data for the defects generated by defect review is more suitable for determining attributes of the defects such as profile, roughness, more accurate size information, etc. Defects can generally be more accurately classified into defect types based on information determined by defect review compared to inspection.

Metrology processes are also used at various steps during a semiconductor manufacturing process to monitor and control the process. Metrology processes are different than inspection processes in that, unlike inspection processes in which defects are detected on a specimen, metrology processes are used to measure one or more characteristics of the specimen that cannot be determined using currently used inspection tools. For example, metrology processes are used to measure one or more characteristics of a specimen such as a dimension (e.g., line width, thickness, etc.) of features formed on the specimen during a process such that the performance of the process can be determined from the one or more characteristics. In addition, if the one or more characteristics of the specimen are unacceptable (e.g., out of a predetermined range for the characteristic(s)), the measurements of the one or more characteristics of the specimen may be used to alter one or more parameters of the process such that additional specimens manufactured by the process have acceptable characteristic(s).

Metrology processes are also different than defect review processes in that, unlike defect review processes in which defects that are detected by inspection are re-visited in defect review, metrology processes may be performed at locations at which no defect has been detected. In other words, unlike defect review, the locations at which a metrology process is performed on a specimen may be independent of the results of an inspection process performed on the specimen. In particular, the locations at which a metrology process is performed may be selected independently of inspection results. In addition, since locations on the specimen at which metrology is performed may be selected independently of inspection results, unlike defect review in which the locations on the specimen at which defect review is to be performed cannot be determined until the inspection results for the specimen are generated and available for use, the locations at which the metrology process is performed may be determined before an inspection process has been performed on the specimen.

Methods and systems for performing the yield related processes described above are often developed by first finding the best possible hardware configuration for generating images, data, measurements, signals, etc. for the specimens. Once the hardware configuration has been established, parameters of the hardware that are best for the processes are selected. Hardware parameter selection can greatly affect how responsive the images, data, measurements, signals, etc. are to the specimen and how well they can be used for determining information for the specimen.

Sometimes even the best possible hardware configuration and associated parameters are not capable of generating output that is ideal (or even good enough) for determining information for a specimen. For example, in the case of the processes described above, the best possible hardware configuration and parameters may still produce images that are less than optimal for detecting or redetecting defects on the specimen, determining information for the defects, measuring characteristics of patterned features on the specimen, etc. Therefore, especially as the tools reach their maximum performance capability, more and more effort is being expended to try to improve the images after they are generated by such tools.

Some currently used methods and systems for improving the images are designed to deblur the images. One such method uses a blind deconvolution algorithm. This method is used when no information about the distortion is known. It attempts to recover the image and the point-spread-function (PSF) simultaneously. Another method uses the Lucy-Richardson algorithm as an iterative procedure for recovering an image that has been blurred by a known, spatially invariant PSF. A different method for image deblurring includes a regularized filter. This approach adds a regularization term to the deconvolution process to handle noise. Yet another method for image deblurring uses a Wiener filter. This method is a statistical approach that assumes knowledge of the spectral properties of the original image and the noise.

There are, however, a number of important disadvantages to the currently used methods and systems for image deblurring. For example, the tasks of image enhancement and restoration are often “ill-posed problems” meaning they involve recovering image information that has been lost during degradation (image acquisition). Reliance on prior knowledge or image models is required to regularize the solution making substantially difficult the implementation of a stable algorithm. In addition, iterative algorithms are by nature slow to execute thereby limiting the applications for which they can be practically used.

Accordingly, it would be advantageous to develop systems and methods for image reconstruction that do not have one or more of the disadvantages described above.

### SUMMARY OF THE INVENTION

The following description of various embodiments is not to be construed in any way as limiting the subject matter of the appended claims.

One embodiment relates to a system configured for image reconstruction. The system includes an imaging subsystem configured for illuminating a specimen with an energy source and generating an image responsive thereto. The specimen has repetitive patterns formed thereon based on a design for semiconductor devices being formed with the specimen. The system also includes a computer system configured for separating the image into patch images smaller than the image. In addition, the system includes a neural network (NN) executed by the computer system and configured for, when the computer system inputs one of the patch images into the neural network, projecting the one of the patch images to a manifold that includes feature vectors learned from training images whose image quality meets or exceeds predetermined criteria. The neural network is also configured for reconstructing the one of the patch images from the feature vectors it aligns to on the manifold thereby generating a reconstructed patch image having one or more image qualities better than the input one of the patch images. The system may be further configured as described herein.

Another embodiment relates to a computer-implemented method for image reconstruction. The method includes illuminating a specimen with an energy source and generating an image responsive thereto with an imaging subsystem. The specimen is configured as described above. The method also includes the separating, projecting, and reconstructing described above. The separating is performed by a computer system, and the projecting and reconstructing are performed by a NN executed by the computer system. Each of the steps of the method described above may be performed as described further herein. The method may include any other step(s) of any other method(s) described herein. The method may be performed by any of the systems described herein.

Another embodiment relates to a non-transitory computer-readable medium storing program instructions executable on a computer system for performing a computer-implemented method for image reconstruction. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIGS. 1 and 2 are schematic diagrams illustrating side views of embodiments of a system configured as described herein;

FIG. 3 is a flow chart illustrating an embodiment of a portion of a neural network (NN) that may be included in the embodiments described herein;

FIG. 4 is a flow chart illustrating an embodiment of NN training that may be performed by the embodiments described herein;

FIG. 5 is a schematic diagram illustrating examples of a patch image input to a NN configured as described herein and a reconstructed patch image generated by the NN;

FIG. 6 is a flow chart illustrating an embodiment of steps that may be performed by the embodiments described herein during runtime; and

FIG. 7 is a block diagram illustrating one embodiment of a non-transitory computer-readable medium storing program instructions for causing a computer system to perform a computer-implemented method described herein.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

In general, the embodiments described herein are configured for image reconstruction. The image reconstruction described herein is particularly useful for specimens having repetitive patterns formed thereon. For example, a specimen, for which image reconstruction is performed as described herein, has repetitive patterns formed thereon based on a design for semiconductor devices being formed with the specimen (e.g., on a specimen such as a wafer or with a specimen such as a reticle). The semiconductor industry relies on computer aided design (CAD) tools, which emphasize the use of hierarchical and common cell instantiation. As a result, the inspected patterns exhibit a remarkably high degree of repetition.

This repetitiveness suggests that a dense and low-dimensional manifold space should exist that can be used for image reconstruction as described further herein. For example, in theory, an image can be represented as a point in a substantially high-dimensional space. An image of size W×H is a set of W×H pixels, where each pixel is represented by a number between 0 and 1. This creates an enormous space, R\hat{ }(w×n), where most points correspond to nothing but noise. If, by extraordinary chance, you land on a point that represents a thing or being of interest, all adjacent points are again just noise. This results in a substantially sparse representation of images corresponding to real objects. In contrast, real images, especially in the semiconductor arts where structures are parameterized by CAD tools (such as straight lines, a small set of predictable angles, e.g., 45 and/or 90, quantized sizes, etc.), have a substantially limited number of possible arrangements compared to other types of images. It is possible to find a relatively low-dimensional subspace (manifold representation) where each point corresponds to a possible arrangement. If this space is built efficiently, close points should have a special relationship (e.g., latent space, etc.). The embodiments described herein take advantage of the nature of the images described herein combined with manifold learning to provide a number of improvements and advantages over other currently used methods for image reconstruction (restoration).

The terms “design,” “design data,” and “design information” as used interchangeably herein generally refer to the physical design (layout) of an IC or other semiconductor device and data derived from the physical design through complex simulation or simple geometric and Boolean operations. The design may include any other design data or design data proxies described in commonly owned U.S. Pat. No. 7,570,796 issued on Aug. 4, 2009 to Zafar et al. and U.S. Pat. No. 7,676,077 issued on Mar. 9, 2010 to Kulkarni et al., both of which are incorporated by reference as if fully set forth herein. In addition, the design data can be standard cell library data, integrated layout data, design data for one or more layers, derivatives of the design data, and full or partial chip design data. Furthermore, the “design,” “design data,” and “design information” described herein refers to information and data that is generated by semiconductor device designers in a design process and is therefore available for use in the embodiments described herein well in advance of printing of the design on any physical specimens such as reticles and wafers.

In some embodiments, the specimen is a wafer on which semiconductor devices are being formed. The wafer may include any wafer known in the semiconductor arts. Although some embodiments may be described herein with respect to a wafer or wafers, the embodiments are not limited in the semiconductor-related specimens for which they can be used. For example, the embodiments described herein may be used for specimens such as reticles, flat panels, personal computer (PC) boards, and other semiconductor specimens. In the case of reticles, the specimen has repetitive patterns formed thereon based on a design for semiconductor devices that are formed (printed) on another specimen using the reticle.

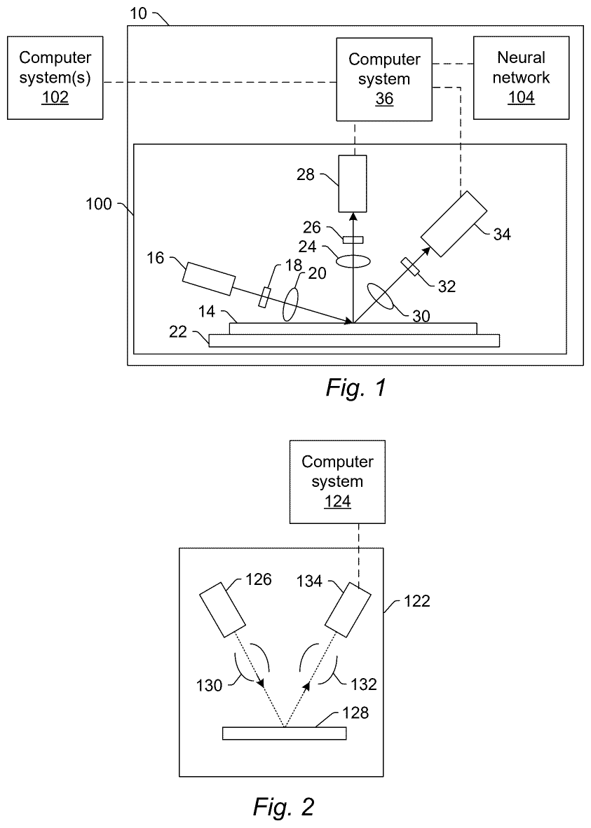

One embodiment of a system configured for image reconstruction is shown in FIG. 1. System 10 includes imaging subsystem 100 configured for illuminating a specimen with an energy source and generating an image responsive thereto. The imaging subsystem may be configured as one of the types of imaging subsystems described herein such as an inspection, metrology, or defect review subsystem, which may include and/or be coupled to computer system 36 and/or one or more computer systems 102.

The terms “imaging system” and “imaging subsystem” are used interchangeably herein and generally refer to the hardware configured for generating images of a specimen. In general, the imaging subsystems described herein include at least an energy source and a detector. The energy source is configured to generate energy that is directed to a specimen. The detector is configured to detect energy from the specimen and to generate output responsive to the detected energy.

In one embodiment, the energy source is a light source. For example, in a light-based imaging subsystem, the energy directed to the specimen includes light, and the energy detected from the specimen includes light. In one such example, as shown in FIG. 1, the imaging subsystem includes an illumination subsystem configured to direct light to specimen 14. The illumination subsystem includes at least one light source, e.g., light source 16. The illumination subsystem is configured to direct the light to the specimen at one or more angles of incidence, which may include one or more oblique angles and/or one or more normal angles. For example, as shown in FIG. 1, light from light source 16 is directed through optical element 18 and then lens 20 to specimen 14 at an oblique angle of incidence. The oblique angle of incidence may include any suitable oblique angle of incidence, which may vary depending on, for instance, characteristics of the specimen and the defects to be detected on the specimen, the characteristics of the specimen to be measured, etc.

The illumination subsystem may be configured to direct the light to the specimen at different angles of incidence. For example, the imaging subsystem may be configured to alter one or more parameters of one or more elements of the illumination subsystem such that the light can be directed to the specimen at an angle of incidence that is different than that shown in FIG. 1. In one such example, the imaging subsystem may be configured to move light source 16, optical element 18, and lens 20 such that the light is directed to the specimen at a different oblique angle of incidence or a normal (or near normal) angle of incidence. The illumination subsystem may have any other suitable configuration known in the art for directing the light to the specimen at one or more angles of incidence sequentially or simultaneously.

The illumination subsystem may also be configured to direct light with different characteristics to the specimen. For example, optical element 18 may be configured as a spectral filter and the properties of the spectral filter can be changed in a variety of different ways (e.g., by swapping out one spectral filter with another) such that different wavelengths of light can be directed to the specimen at different times.

Light source 16 may include a broadband plasma (BBP) light source. In this manner, the light generated by the light source and directed to the specimen may include broadband light. However, the light source may include any other suitable light source such as any suitable laser known in the art configured to generate light at any suitable wavelength(s). In addition, the laser may be configured to generate light that is monochromatic or nearly-monochromatic. In this manner, the laser may be a narrowband laser. The light source may also include a polychromatic light source that generates light at multiple discrete wavelengths or wavebands.

Light from optical element 18 may be focused onto specimen 14 by lens 20. Although lens 20 is shown in FIG. 1 as a single refractive optical element, in practice, lens 20 may include a number of refractive and/or reflective optical elements that in combination focus the light from the optical element to the specimen. The illumination subsystem shown in FIG. 1 and described herein may include any other suitable optical elements (not shown). Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art. In addition, the system may be configured to alter one or more elements of the illumination subsystem based on the type of illumination to be used for imaging.

The imaging subsystem may also include a scanning subsystem configured to change the position on the specimen to which the light is directed and from which the light is detected and possibly to cause the light to be scanned over the specimen. For example, the imaging subsystem may include stage 22 on which specimen 14 is disposed during imaging. The scanning subsystem may include any suitable mechanical and/or robotic assembly (that includes stage 22) that can be configured to move the specimen such that the light can be directed to and detected from different positions on the specimen. In addition, or alternatively, the imaging subsystem may be configured such that one or more optical elements of the imaging subsystem perform some scanning of the light over the specimen such that the light can be directed to and detected from different positions on the specimen. The light may be scanned over the specimen in any suitable fashion such as in a serpentine-like path or in a spiral path.

The imaging subsystem includes one or more detection channels. At least one of the detection channel(s) includes a detector configured to detect light from the specimen due to illumination of the specimen by the system and to generate output responsive to the detected light. The imaging subsystem shown in FIG. 1 includes two detection channels, one formed by collector 24, element 26, and detector 28 and another formed by collector 30, element 32, and detector 34. The two detection channels are configured to collect and detect light at different angles of collection. In some instances, both detection channels are configured to detect scattered light, and the detection channels are configured to detect light that is scattered at different angles from the specimen. However, one or more of the detection channels may be configured to detect another type of light from the specimen (e.g., reflected light).

In FIG. 1, both detection channels are shown positioned in the plane of the paper and the illumination subsystem is also shown positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 30, element 32, and detector 34 may be configured to collect and detect light that is scattered out of the plane of incidence. Therefore, such a detection channel may be commonly referred to as a “side” channel, and such a side channel may be centered in a plane that is substantially perpendicular to the plane of incidence.

Although FIG. 1 shows an embodiment of the imaging subsystem that includes two detection channels, the imaging subsystem may include a different number of detection channels (e.g., only one detection channel or two or more detection channels). The detection channel formed by collector 30, element 32, and detector 34 may form one side channel as described above, and the imaging subsystem may include an additional detection channel (not shown) formed as another side channel that is positioned on the opposite side of the plane of incidence. Therefore, the imaging subsystem may include the detection channel that includes collector 24, element 26, and detector 28 and that is centered in the plane of incidence and configured to collect and detect light at scattering angle(s) that are at or close to normal to the specimen surface. This detection channel may therefore be commonly referred to as a “top” channel, and the imaging subsystem may also include two or more side channels configured as described above. As such, the imaging subsystem may include at least three channels (i.e., one top channel and two side channels), and each of the at least three channels is configured to collect light at different scattering angles than each of the other collectors.

As described further above, one or more of the detection channels may be configured to detect scattered light. Therefore, the imaging subsystem shown in FIG. 1 may be configured for dark field (DF) imaging. However, the imaging subsystem may also or alternatively include detection channel(s) that are configured for bright field (BF) imaging. Therefore, the imaging subsystems described herein may be configured for only DF, only BF, or both DF and BF imaging. Although each of the collectors are shown in FIG. 1 as single refractive optical elements, each of the collectors may include refractive optical element(s) and/or reflective optical element(s).

The one or more detection channels may include any suitable detectors known in the art such as photo-multiplier tubes (PMTs), charge coupled devices (CCDs), and time delay integration (TDI) cameras. The detectors may also include non-imaging detectors or imaging detectors. If the detectors are non-imaging detectors, each of the detectors may be configured to detect certain characteristics of the light such as intensity but may not be configured to detect such characteristics as a function of position within the imaging plane. As such, the output that is generated by each of the detectors in each of the detection channels may be signals or data, but not image signals or image data. In such instances, a computer system may be configured to generate images of the specimen from the non-imaging output of the detectors. However, in other instances, the detectors may be configured as imaging detectors that are configured to generate imaging signals or image data. Therefore, the imaging subsystem may be configured to generate images in a number of ways.

Computer system 36 may be coupled to the detectors of the imaging subsystem in any suitable manner (e.g., via one or more transmission media, which may include “wired” and/or “wireless” transmission media) such that the computer system can receive the output generated by the detectors. Computer system 36 may be configured to perform a number of functions using the output of the detectors as described further herein. Computer system 36 may be further configured as described herein.

Computer system 36 (as well as other computer systems described herein) may also be referred to herein as computer subsystem(s). Each of the computer subsystem(s) or system(s) described herein may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and software, either as a standalone or a networked tool.

If the system includes more than one computer system, then the different computer systems may be coupled to each other such that images, data, information, instructions, etc. can be sent between the computer systems. For example, computer subsystem 36 may be coupled to computer system(s) 102 as shown by the dashed line in FIG. 1 by any suitable transmission media, which may include any suitable wired and/or wireless transmission media known in the art. Two or more of such computer systems may also be effectively coupled by a shared computer-readable storage medium (not shown).

In another embodiment, the energy source is an electron beam source. For example, in an electron beam imaging subsystem, the energy directed to the specimen includes electrons, and the energy detected from the specimen includes electrons. In one such embodiment shown in FIG. 2, the imaging subsystem includes electron column 122, and the system includes computer system 124 coupled to the imaging subsystem. Computer system 124 may be configured as described above. In addition, such an imaging subsystem may be coupled to another one or more computer systems in the same manner described above and shown in FIG. 1.

As also shown in FIG. 2, the electron column includes electron beam source 126 configured to generate electrons that are focused to specimen 128 by one or more elements 130. The electron beam source may include, for example, a cathode source or emitter tip, and one or more elements 130 may include, for example, a gun lens, an anode, a beam limiting aperture, a gate valve, a beam current selection aperture, an objective lens, and a scanning subsystem, all of which may include any such suitable elements known in the art.

Electrons returned from the specimen (e.g., secondary electrons) may be focused by one or more elements 132 to detector 134. One or more elements 132 may include, for example, a scanning subsystem, which may be the same scanning subsystem included in element(s) 130.

The electron column may include any other suitable elements known in the art. In addition, the electron column may be further configured as described in U.S. Pat. No. 8,664,594 issued Apr. 4, 2014 to Jiang et al., U.S. Pat. No. 8,692,204 issued Apr. 8, 2014 to Kojima et al., U.S. Pat. No. 8,698,093 issued Apr. 15, 2014 to Gubbens et al., and U.S. Pat. No. 8,716,662 issued May 6, 2014 to MacDonald et al., which are incorporated by reference as if fully set forth herein.

Although the electron column is shown in FIG. 2 as being configured such that the electrons are directed to the specimen at an oblique angle of incidence and are scattered from the specimen at another oblique angle, the electron beam may be directed to and scattered from the specimen at any suitable angles. In addition, the electron beam imaging subsystem may be configured to use multiple modes to generate output for the specimen as described further herein (e.g., with different illumination angles, collection angles, etc.). The multiple modes of the electron beam imaging subsystem may be different in any output generation parameters of the imaging subsystem.

Computer system 124 may be coupled to detector 134 as described above. The detector may detect electrons returned from the surface of the specimen thereby forming electron beam images of (or other output for) the specimen. The electron beam images may include any suitable electron beam images. Computer system 124 may be configured to perform any step(s) described herein. A system that includes the imaging subsystem shown in FIG. 2 may be further configured as described herein.

FIGS. 1 and 2 are provided herein to generally illustrate configurations of an imaging subsystem that may be included in the system embodiments described herein. Obviously, the imaging subsystem configurations described herein may be altered to optimize the performance of the imaging subsystem as is normally performed when designing a commercial imaging system. In addition, the systems described herein may be implemented using an existing imaging subsystem (e.g., by adding functionality described herein to an existing inspection system) such as the tools that are commercially available from KLA Corp., Milpitas, Calif. For some such systems, the methods described herein may be provided as optional functionality of the imaging subsystem (e.g., in addition to other functionality of the imaging system). Alternatively, the imaging system described herein may be designed “from scratch” to provide a completely new system.

Although the imaging subsystem is described above as being a light or electron beam imaging subsystem, the imaging subsystem may be an ion beam imaging subsystem. Such an imaging subsystem may be configured as shown in FIG. 2 except that the electron beam source may be replaced with any suitable ion beam source known in the art. In addition, the imaging subsystem may include any other suitable ion beam system such as those included in commercially available focused ion beam (FIB) systems, helium ion microscopy (HIM) systems, and secondary ion mass spectroscopy (SIMS) systems.

The imaging subsystem may be configured to generate output, e.g., images, of the specimen with multiple modes. In general, a “mode” is defined by the values of parameters of the imaging subsystem used for generating images of a specimen (or the output used to generate images of the specimen). Therefore, modes may be different in the values for at least one of the parameters of the imaging subsystem (other than lateral position on the specimen at which the output is generated). For example, the modes may be different in any one or more alterable parameters (e.g., illumination polarization(s), angle(s), wavelength(s), etc., detection polarization(s), angle(s), wavelength(s), etc.) of the imaging subsystem. The imaging subsystem may be configured to scan the specimen with the different modes in the same scan or different scans, e.g., depending on the capability of using multiple modes to scan the specimen at the same time.

In a similar manner, the electron beam subsystem may be configured to generate images with two or more modes, which can be defined by the values of parameters of the electron beam subsystem used for generating images for a specimen. Therefore, modes may be different in the values for at least one of the electron beam parameters of the electron beam subsystem. For example, different modes may use different angles of incidence for illumination.

The imaging subsystems described herein may be configured as an inspection system, a metrology system, and/or a defect review system. For example, the embodiments of the imaging subsystem shown in FIGS. 1 and 2 may be modified in one or more parameters to provide different imaging capability depending on the application for which it will be used. In one such example, the imaging subsystem may be configured to have a higher resolution if it is to be used for metrology rather than for inspection. In other words, the embodiments of the imaging subsystem shown in FIGS. 1 and 2 describe some general and various configurations for an imaging subsystem that can be tailored in a number of manners that will be obvious to one skilled in the art to produce systems having different imaging capabilities that are more or less suitable for different applications.

In this manner, the imaging subsystem may be configured for generating output that is suitable for detecting or re-detecting defects on the specimen in the case of an inspection system or a defect review system, respectively, and for measuring one or more characteristics of the specimen in the case of a metrology system. In an inspection system, computer system 36 shown in FIG. 1 may be configured for detecting defects on specimen 14 by applying a defect detection method or algorithm to output generated by one or more of the detectors or according to one or more embodiments described herein. In a defect review system, computer system 124 shown in FIG. 2 may be configured for re-detecting defects on specimen 128 by applying a defect re-detection method to the output generated by detector 134 and possibly determining additional information for the re-detected defects using the output generated by the detector. In a metrology system, computer system 36 shown in FIG. 1 may be configured for determining one or more characteristics of specimen 14 using the output generated by detectors 28 and/or 34. The system may be further configured for detecting or re-detecting defects on the specimen, determining characteristics of the specimen, determining other information for the specimen, etc. as described further herein.

As noted above, the imaging subsystem is configured for scanning energy (e.g., light, electrons, etc.) over a physical version of the specimen thereby generating output for the physical version of the specimen. In this manner, the imaging subsystem may be configured as an “actual” subsystem, rather than a “virtual” subsystem. However, a storage medium (not shown) and computer system(s) 102 shown in FIG. 1 may be configured as a “virtual” system. In particular, the storage medium and the computer system(s) may be configured as a “virtual” imaging system as described in commonly assigned U.S. Pat. No. 8,126,255 issued on Feb. 28, 2012 to Bhaskar et al. and U.S. Pat. No. 9,222,895 issued on Dec. 29, 2015 to Duffy et al., which are incorporated by reference as if fully set forth herein. The embodiments described herein may be further configured as described in these patents.

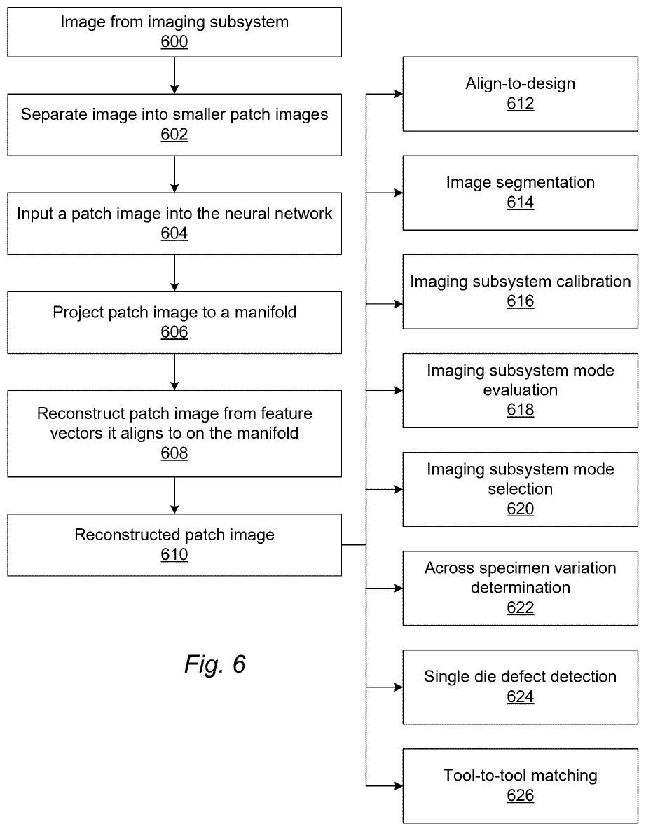

The system includes a computer system, which may include any configuration of any of the computer subsystem(s) or system(s) described above. The computer system is configured for separating the image (image from imaging subsystem 600 shown in FIG. 6) into patch images smaller than the image (as shown in step 602). For example, an image with relatively high resolution, such as a scanning electron microscope (SEM) image with dimensions of 1024×1024 pixels, may be divided into smaller patch images, each measuring 128×128 pixels. The input and patch image sizes may, however, vary depending on the imaging subsystem configuration, how the images generated by the imaging subsystem configuration are usually processed for inspection, defect review, and/or metrology, and the configuration of the embodiments described herein. Separating the image into patch images, which are subsequently input to a NN as described herein, is a surprisingly important step for the embodiments described herein. For example, the idea that a manifold should exist for the specimen images described herein was not obvious and seems to work only when the inventors divided the image into smaller patch images to match the low dimension representation.

The embodiments described herein have been found to be particularly interesting in the context of SEM image restoration and automatic tool calibration. The images that are input to the separating step may, however, include any of the imaging subsystem output described further herein such as images, image data, signals, image signals, etc. The images that are input to the separating step may include the raw detector output, meaning that the detector output is not processed in any manner prior to the separating step. However, the image that is input to the separating step may be an image that has been processed in some manner as it might be in a normal inspection (or other) process. Such processing may include, for example, high pass filtering, image alignment, and the like.

Each (or at least one) of the patches into which the input image is separated may be separately reconstructed (restored) as described further herein. For example, only one of the image patches may be reconstructed at the location of a detected defect in the original image, only one of the image patches may be reconstructed and then used for alignment of the original image, or only one of the image patches may be reconstructed and used for any other purpose. Such limited patch image reconstruction may be performed when time and other resources are limited (even though the embodiments described herein may be faster than other currently available image restoration methods and systems). However, the image reconstruction described herein may be performed for any or all of the image patches into which the original image is separated. Reconstructing all of the image patches may be also performed depending on the reason for the image reconstruction. For example, not all image patches may need to be reconstructed for image alignment, but all image patches may be reconstructed when defect detection is performed using the reconstructed image patches.

The system also includes a neural network (NN) 104 shown in FIG. 1 executed by the computer system and configured for, when the computer system inputs one of the patch images into the NN (as shown in step 604 in FIG. 6), projecting the one of the patch images to a manifold (as shown in step 606) that includes feature vectors learned from training images whose image quality meets or exceeds predetermined criteria. For example, the image patches are transformed into a compact manifold feature vector with a dimensionality of just 64 (1×64), yet they retain the complete information necessary to reconstruct the original 128×128 pixel patch.

In one embodiment, the manifold is a low dimensional representation of the training images that preserves the relationships between data points in the training images. Unlike an autoencoder, which is designed to simply compress data, the manifold approach focuses on uncovering and utilizing the intrinsic patterns or geometric properties present within the data of higher dimensions. The goal of manifold learning is to find a low-dimensional representation of the data that preserves the important relationships between data points.

In another embodiment, the NN is configured for learning the feature vectors by unsupervised learning. In an additional embodiment, the training images are generated by the imaging subsystem with best known parameters of the imaging subsystem. The premise is that the manifold is unsupervised learned from a collection of relatively high-quality images, preferably reflecting optimal imaging subsystem conditions like focus, astigmatism, and high signal-to-noise ratio (SNR). The predetermined criteria that is met or exceeded by the training images may be defined by criteria for any of such conditions or any other suitable image quality or qualities that may vary depending on the reasons for generating the images. For example, the predetermined criteria may include one or more of the following image qualities: in-focus images, images lacking astigmatism or having astigmatism below a certain measure, images having a SNR above some threshold, images having at least a predetermined qualitative or quantitative image sharpness, contrast, etc. In this manner, the training images may be high quality images, where what qualifies or quantifies as high quality may be determined by a user, the reason for generating the images, the specimen, the imaging subsystem, and any other such parameters of the methods and systems described herein.

The optimal imaging subsystem conditions may include or be determined from one or more best known modes (BKMs) for a process performed on the specimen with the images generated by the imaging subsystem. For example, the computer system may select one or more BKMs for a process as the optimal imaging subsystem conditions. The computer system may identify or determine the BKMs in any suitable manner. For example, the BKM(s) may be identified by searching a storage medium (e.g., a fab database or storage medium accessible to the computer system) for a process recipe for the process and specimen and identifying the mode(s) in the process recipe as the optimal imaging subsystem conditions. In this manner, the optimal imaging subsystem conditions may vary depending on the process (e.g., array inspection vs. logic inspection, inspection vs. metrology, etc.) and the specimen type (a post-etch wafer vs. a post-lithography wafer, a wafer vs. a reticle, a wafer with front end layers formed thereon vs. a wafer having back end layers formed thereon, etc.).

Instead of BKMs, the computer system may select a default set of best known imaging parameters for the imaging subsystem as the optimal imaging subsystem conditions even if those imaging parameters are perhaps not suitable for a process, e.g., they may be too slow for a whole specimen inspection process even though they may be the best available imaging parameters on the tool.

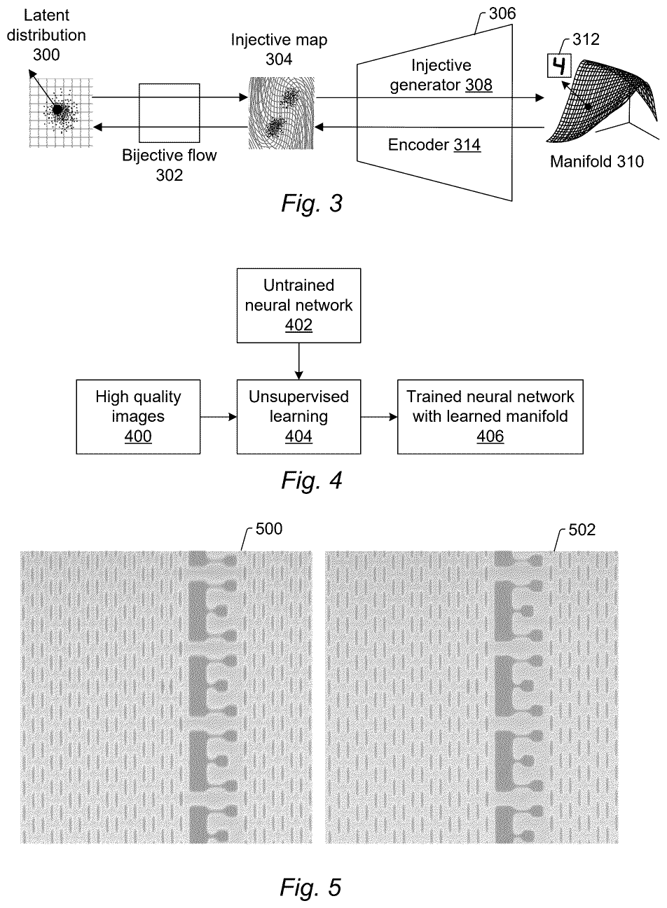

In one such embodiment, as shown in FIG. 4, high quality images 400 and an untrained (or to be trained) neural network 402 may be input to unsupervised learning step 404 to thereby generate results 406 including a trained neural network with a learned manifold. In general, the unsupervised training means that the high quality images used for training are unlabeled; however, the unsupervised training may be performed in any suitable manner known in the art. The computer system may be configured to perform the unsupervised training. Alternatively, another system or method may perform the unsupervised training, and the computer system may acquire or access the trained NN from the other system or method or a computer-readable storage medium in which the other system or method has stored it. In this manner, one entity may set up and train the NN, and another entity may use the NN as described herein.

In some instances, an NN trained with images for one specimen may be used to reconstruct images for a different specimen, which may or may not have the same design formed thereon. For example, high quality images may be generated for each specimen on a specimen-by-specimen basis so that an NN can be trained for each specimen. However, such training or re-training of the NN for each specimen may not be necessary, and, for specimens whose designs and images are similar enough, a trained NN may be reused without re-training.

The NN is also configured for reconstructing the one of the patch images from the feature vectors it aligns to on the manifold (as shown in step 608 of FIG. 6) thereby generating a reconstructed patch image (reconstructed patch image 610) having one or more image qualities better than the input one of the patch images. When a degraded image, such as one that's blurred or has relatively low SNR, is projected onto the manifold, it aligns with the feature vector of a clean image. For example, when a degraded image is projected to the manifold, it does not land exactly on the manifold because it is degraded. However, because of the manifold property (dense representation), if the computer system or the NN move from the projection point to the closest point on the manifold and reconstruct the image, the reconstructed image is guaranteed to have a “possible” pattern, which means sharp and clean (assuming here that the manifold was created using only sharp and clean patterns). Concretely, the NN is learning to transform the image (high dimension) to a lower dimension (manifold) and to expand from that representation to the original one.

The embodiments described herein are therefore different from other methods of image “reconstruction” in a number of important ways. For example, in general, in high dimensional space, it is not possible to resolve (e.g., solve the inverse problem, etc.) by direct maximum a posteriori (MAP) estimation (or intractable computation). But, when the data can be represented in a low-dimensional manifold, then a simple flow (e.g., normalizing flow) can be used to compute and to maximize the likelihood via invertible transformation. normalizing flow, gradient descent, etc. To keep it simple, if the problem can be decomposed into 2 steps, then the first step is dimension reduction—manifold projection by injective transformation and the second step is MAP estimation in low dimension, thereby providing an end-to-end solution to recover degraded large resolution images.

Consequently, the reconstruction process yields an image that has one or more better image qualities than the input patch image. For example, the reconstructed image may be sharp and/or free of noise. In one embodiment, therefore, the one or more image qualities of the reconstructed patch image include less blur than the input one of the patch images. FIG. 5 illustrates one example of manifold reconstruction for image deblurring. In particular, image 500 is an example of a patch image that may be input to the NN as described herein. Image 502 is an example of a reconstructed patch image that may be generated by image restoration via manifold reconstruction performed as described herein. As can be easily seen by comparing images 500 and 502, the reconstructed image has significantly less blur than the input image. In another embodiment, the one or more image qualities of the reconstructed patch image include less noise than the input one of the patch images. In other words, the reconstructed patch images may be quieter than the input images and have higher SNR for specimen features and defects than the input images.

The NN included in the system may have any suitable network topology, optimization process, loss function, likelihood estimation, etc. known in the art. FIG. 3 illustrates one example of a portion of a NN that may be used for the embodiments described herein. In this example, latent distribution 300 may be generated by one or more layers (not shown) included in the NN for an input patch image. The arrows pointing to the right in the figure indicate the sample generating steps, and the arrows pointing to the left in the figure indicate the encoding data flow. For sample generation, the latent distribution is input to bijective flow 302, which projects the latent distribution to injective map 304. The injective map projection for the input latent distribution is input to injective generator 308 portion of NN layers 306 that projects the injective map projection for the input latent distribution to manifold 310. Data 312 to which the injective map projection aligns may be input to encoder 314 included in layers 306 that encodes that data back to injective map 304 space. The portion of the injective map corresponding to data 312 may be then input to bijective flow 302, which outputs a corresponding latent distribution that may be input to other layers (not shown) of the NN to thereby generate a reconstructed patch image. Examples of suitable NN configurations that may be used in the embodiments described herein can also be found in “TRUMPETS: Injective Flows for Inference and Inverse Problems,” by Kothari et al., arXiv:2102.10461v1, Feb. 20, 2021, 16 pages, which is incorporated by reference as if fully set forth herein. The embodiments described herein may be further configured as described in this reference.

In one embodiment, the computer system is configured for aligning the reconstructed patch image to the design (e.g., as in align-to-design step 612 shown in FIG. 6). For example, one particularly useful and important application of the embodiments described herein is image-to-design alignment, e.g., CAD-to-SEM alignment. The images captured during rapid acquisition processes (like inspection) frequently exhibit issues like suboptimal focus and a relatively low SNR, especially when only a single frame is collected. These imperfections can significantly hinder the accuracy of SEM to CAD registration algorithms to mitigate this challenge. Manifold image restoration can be employed as described herein to enhance image quality before attempting CAD registration.

Once one reconstructed patch image has been aligned to design, other patch images in the original image can be aligned to design based on the one aligned reconstructed patch image (e.g., using a simple coordinate transformation determined from the reconstructed patch image aligned to design). Alternatively, each patch image (or as many patch images as desired) into which an original image has been separated may be reconstructed and then separately aligned to design.

The image-to-design alignment algorithm or method into which the reconstructed patch image is input may be any suitable alignment algorithm or method known in the art. In other words, the reconstructed images generated by the embodiments described herein may be used for image-to-design alignment in the same manner as any other images currently input to such algorithms and methods.

In another embodiment, the computer system is configured for segmenting the reconstructed patch image based on one or more characteristics of the reconstructed patch image (as in image segmentation step 614 shown in FIG. 6). For example, another particularly useful and important application of the embodiments described herein is image segmentation. It is typically difficult to locate objects and boundaries in a relatively low-quality image. Assigning a label to every pixel in an image such that pixels with the same label share certain characteristics (noise, etc.) is crucial for defect detection (e.g., so that pixels sharing certain characteristics can be inspected with the same inspection sensitivity). As with image to design alignment, it may be possible to segment one reconstructed patch image and then use those segmentation results to segment other original patch images. However, if desired, it is also possible to reconstruct each patch image and then segment each reconstructed patch image. The image segmentation algorithm or method into which a reconstructed patch image is input may be any suitable image segmentation algorithm or method known in the art. In other words, the reconstructed patch images generated by the embodiments described herein may be used for image segmentation in the same manner as any other images currently input to such algorithms and methods.

The computer system may be further configured for imaging subsystem calibration, as shown in step 616 of FIG. 6. For example, in an additional embodiment, the computer system is configured for automatic calibration of the imaging subsystem based on differences between the reconstructed patch image and the input one of the patch images. In a further embodiment, the computer system is configured for automatically calibrating the imaging subsystem based on differences between the reconstructed patch image and the input one of the patch images while a process is performed on the specimen with the imaging subsystem. For example, an additional particularly useful and important application of the embodiments described herein is automatic tool calibration, which may or may not be performed during runtime of a process.

During relatively long inspection operations, it is imperative to keep the system, like the column configuration in e-beam systems, perfectly calibrated. Such calibration is, however, a substantially challenging task, particularly with relatively sophisticated multi-beam systems like those that may include as many as 300 beams. Using the embodiments described herein (manifold image restoration), a side-by-side evaluation can be performed of the unprocessed image against the idealized version. The results of such evaluation enable the fine-tuning of calibration parameters to reduce discrepancies, ultimately leading to perfect calibration of the tool. This operation can be performed in situ (keeping the wafer on stage). The imaging subsystem calibration algorithm or method into which the reconstructed patch image is input may also be any suitable calibration algorithm or method known in the art. In other words, the reconstructed patch images generated by the embodiments described herein may be used for imaging subsystem calibration in the same manner as any other images currently input to such algorithms and methods.

One significant advantage of the embodiments described herein for applications such as automatic calibration described above and possibly others described herein is the practicality of performing the image reconstruction and therefore applications with the reconstructed images in real time (or near real time). For example, the NN may generate reconstructed (or idealized) images for patch images as they are generated, and the computer system may continuously compare produced images with their idealized ones for the purpose of improving flow robustness, flow throughput, image consistency, image calibration, etc. While such image reconstruction and use may be particularly advantageous for some of the applications described herein, any of the image reconstruction and applications described herein may of course be performed off-line or off-tool, e.g., after all of the images for a specimen have been generated and/or by a computer system not coupled to the imaging subsystem (such as computer system(s) 102 shown in FIG. 1).

The computer subsystem may also be configured for imaging subsystem mode evaluation, as shown in step 618 of FIG. 6. For example, another particularly useful and important application of the embodiments described herein is mode evaluation, or simply determining information for a mode of the imaging subsystem. In one such embodiment, the training images are generated for one or more first dies on the specimen, the projecting and reconstructing are performed for additional patch images generated for second dies on the specimen thereby generating corresponding reconstructed additional patch images, and the computer system is configured for determining information for a mode of the imaging subsystem used for generating the additional patch images based on differences between the additional patch images and their corresponding reconstructed additional patch images.

This embodiment may be useful because an imaging parameter, or mode, preferably results in images that are not affected by variations in the process or specimen (e.g., color variations) that are not of interest. The embodiments described herein can be used to learn the manifold on a specific die on the specimen (e.g., one or more center dies) and to perform a side-by-side evaluation of the unprocessed image against the idealized version across other different dies on the specimen. The mode can then be evaluated based on how different the generated images are from their idealized versions as a function of die or other location on the specimen. For example, a mode that exhibits the same (or substantially the same) differences between corresponding idealized and original images for different locations on the specimen may be advantageously more insensitive to process or specimen variations (like color) than one whose corresponding idealized and original images have differences that vary as a function of position on the specimen.

The mode evaluation algorithm or method into which the reconstructed patch images are input may also be any suitable mode evaluation algorithm or method known in the art. In other words, the reconstructed images generated by the embodiments described herein may be used for mode evaluation in the same manner as any other images currently input to such algorithms and methods. The mode evaluation described above may be also performed as part of the mode selection application described herein.

The embodiments described herein may be further configured for imaging subsystem mode selection, as shown in step 620 of FIG. 6. For example, an additional particularly useful and important application of the embodiments described herein is image mode selection, which may be particularly important for BBP type inspection tools and SEM tools. In one such embodiment, the training images are generated for one or more first dies on the specimen, the projecting and reconstructing are performed for additional patch images generated for second dies on the specimen with multiple modes of the imaging subsystem thereby generating corresponding reconstructed additional patch images for different combinations of the second dies and the multiple modes, and the computer system is configured for selecting one or more of the multiple modes for a process performed on the specimen with the imaging subsystem based on differences between the additional patch images and their corresponding reconstructed additional patch images. This embodiment is suitable for situations in which the optimal imaging parameters, such as mode selected, should result in an image that is not affected by variations in the process or specimen (e.g., color variations) that are not of interest. The embodiments described herein can be used to learn the manifold on specific die(s) on the specimen (one or more center dies) and to perform a side-by-side evaluation of the unprocessed image against the idealized version across other, different dies on the specimen.

In another mode selection possibility, differences between the idealized images and the original images may be determined for different modes. In this manner, it may be possible to determine how far away from ideal, a mode's images are. In other words, a comparison between the reconstructed and original images may be performed to determine how similar the images are, which may be determined in a quantifiable way (e.g., based on SNR) when possible or in a qualitative way for image qualities that are not easily quantified. Then, one or more modes whose generated images are most similar to the reconstructed images may be selected for a process performed on the specimen. In some cases for a process like inspection, it may also be useful to select multiple modes having dramatically different capabilities for imaging the specimen and such modes may also be selected based on the comparison results described above.

The mode selection algorithm or method into which the reconstructed patch images are input may also be any suitable mode selection algorithm or method known in the art. In other words, the reconstructed images generated by the embodiments described herein may be used for mode selection in the same manner as any other images currently input to such algorithms and methods.

Once the mode(s) have been selected for the process, the computer system or another method or system may select one or more other parameters for the process. Such parameters may include any image processing parameters, any parameters of a method or system that will be used to determine information from the images generated with the selected mode(s) like a defect detection algorithm, any parameters of a method or system that will be used to determine additional information for the specimen from the determined information, any parameters of a method or system that will be used to generate results for the process, etc. To give just one example, the computer subsystem may be configured to determine a threshold of a defect detection method that will be applied to the images generated by a selected mode to detect defects in the images. Such parameters may be selected in any suitable manner known in the art.

In an additional embodiment, the training images are generated for one or more first dies on the specimen, the projecting and reconstructing are performed for additional patch images generated for second dies on the specimen thereby generating corresponding reconstructed additional patch images, and the computer system is configured for determining across specimen variation (as shown in step 622 of FIG. 6) in a characteristic of the specimen based on differences between the additional patch images and their corresponding reconstructed additional patch images. For example, another particularly useful and important application of the embodiments described herein is cross wafer process variation estimation.

The training images may be generated as described herein, and the first die(s) may be, for example, one or more center dies on the specimen. The projecting and reconstructing for the second die images may be performed as described herein, and the computer system may determine differences in any suitable characteristic(s) of the specimen as a function of position on the specimen based on the differences between the original and reconstructed patch images for the second dies.

The specimen characteristic used for this application may be unrelated to discrete defects that may or may not also be detected on the specimen as described herein. For example, the specimen characteristic may be a color variation, a film thickness, and the like that may not necessarily be defects or defective characteristics of the specimen but can be detected by the comparisons described above and used to determine potentially important information about the specimen or a process performed on it as a function of position across the specimen. The specimen characteristic(s) and its/their variation across the specimen may otherwise be determined using any suitable method or algorithm known in the art.

Another particularly useful and important application of the embodiments described herein is single die detection. For example, in a further embodiment, the computer system is configured for performing single die defect detection (as shown in step 624 in FIG. 6) for the specimen by identifying differences between the input one of the patch images and the reconstructed patch image and detecting defects in the one of the patch images based on the identified differences. In this type of defect detection, the collected, i.e., original or input, image may be compared to the idealized or reconstructed one. In this manner, the input image may be the test image, and the reconstructed image may be used as a reference.

In other words, if a high quality image with a defect on it is input to the NN, after projection to the manifold and reconstruction, all the portions of the image should be reconstructed accurately except the defect itself. The differences may then be used to identify defects in the collected image. In particular, by subtracting the idealized image from the original image, the only difference should be the defect. Therefore, this type of defect detection may also be considered single image defect detection in which defect detection is performed with a self-generated reference.

This type of defect detection may be performed for any images input to the NN and not just for dies. For example, such defect detection may be performed as single cell detection, single frame detection, single array area detection, single field detection, and the like.

Of course, single die defect detection is just one type of defect detection in which the images described herein may be used. In particular, the reconstructed and original images may be input to any suitable defect detection algorithm or method known in the art. In other words, the reconstructed images generated by the embodiments described herein and the original images input to the NN may be used for defect detection in the same manner as any other images currently input to such algorithms and methods. For example, the defect detection algorithm may be the MDAT algorithm that is available on some inspection tools commercially available from KLA. The defect detection algorithm may also include a deep learning (DL) type defect detection algorithm.

The embodiments described herein may also be configured for tool-to-tool matching, as shown in step 626 of FIG. 6. In some such embodiments, the training images are generated by a different imaging subsystem, and the computer system is configured for adjusting one or more parameters of the imaging subsystem to match the different imaging subsystem based on differences between the input one of the patch images and the reconstructed patch image. For example, a user may want to achieve perfect (or as near perfect as possible) matching between two different e-beam tools, tool 1 and tool 2. The manifold may be learned on tool 1 (the reference tool), and the embodiments described herein may adjust tool 2 to produce images that minimize the differences with the manifold reconstructed image. The one or more parameters of tool 2 that are adjusted to produce images minimizing such differences may include any of the imaging subsystem parameters described herein. The embodiments described herein may identify and adjust such parameters in any suitable manner known in the art.

The embodiments described herein provide a number of significant improvements and advantages for image reconstruction and the applications described herein compared to currently used methods and systems. For example, the embodiments described herein for image restoration leverage advancements in DL, which have revolutionized the field of computer vision. DL methods, particularly convolutional neural networks (CNNs), have become the cornerstone for solving complex computer vision tasks. These methods have several advantages over traditional image restoration techniques.

One such advantage is improved accuracy. For example, DL models can learn and generalize from a vast amount of data, leading to more accurate image analysis and recognition. Another advantage is feature extraction. CNNs automatically detect and utilize the most relevant features from images, bypassing the need for manual feature engineering. An additional advantage is versatility. DL models can handle a wide range of computer vision tasks, from image classification to object detection and segmentation. A further advantage is adaptability. These models can be trained on new data to improve their performance over time, making them adaptable to various scenarios.

By incorporating recent research in DL, the embodiments described herein aim to overcome the limitations of traditional methods and provide a more robust solution for image restoration and enhancement in computer vision. Rather than relying on assumed image priors to direct the algorithm in addressing image restoration challenges, the embodiments described herein only rely on the availability of a collection of relatively high-quality images. These images should be produced under meticulous and unhurried conditions. The model will then be trained to recognize the appearance of a pristine image when presented with its degraded counterpart.

The advantages described above are provided by a number of important new features of the embodiments described herein. For example, due to the repetitive nature of CAD designed chips, the inventors have discovered that a low dimensional representation must exist. Learning this manifold enables the embodiments described herein to recast the image restoration problem as a projection and reconstruction process. Any deviation from exact manifold representation due to image degradation, noise, blurring, etc. can be recovered by the embodiments described herein.

The computer system may be configured for storing the reconstructed images, the original images, any information for the specimen, the imaging subsystem, etc., and/or any other results generated by the embodiments described herein in any suitable computer-readable storage medium. Any of such images, information, results, etc. described herein may be stored in any manner known in the art. The storage medium may include any storage medium described herein or any other suitable storage medium known in the art. After the information has been stored, the information can be accessed in the storage medium and used by any of the method or system embodiments described herein, formatted for display to a user, used by another software module, method, or system, etc.

In some embodiments that perform mode selection, for example, the computer system may be configured for storing information for the selected mode(s) for the next steps of the mode selection process and/or for use in a process such as inspection of the specimen. The computer system may be configured to store the information in a recipe or by generating a recipe for the process in which the selected mode(s) will be used. A “recipe” as that term is used herein can be generally defined as a set of instructions that can be used by a tool to perform a process on a specimen. In this manner, generating a recipe may include generating information for how a process is to be performed, which can then be used to generate the instructions for performing that process. The information for the selected mode(s) that is stored by the computer system may include any information that can be used to identify and/or use the selected mode(s) (e.g., such as a file name and where it is stored, and the file may include information for the modes such as mode names, mode parameter values, etc.). That inspection recipe may then be stored and used by the system or method (or another system or method) to inspect the specimen or other specimens to thereby generate information (e.g., defect information) for the specimen or other specimens.

The computer system and/or the inspection system may be configured to use the results of one or more steps described herein to perform the inspection process on the specimen and/or other specimens of the same type. Such an inspection process may produce results for any defects detected on the specimen(s) such as information, e.g., location, etc., of the bounding boxes of the detected defects, detection scores, information about defect classifications such as class labels or IDs, etc., or any such suitable information known in the art. The results for the defects may be generated by the computer system and/or inspection system in any suitable manner. The results for the defects may have any suitable form or format such as a standard file type. The computer system and/or inspection system may generate the results and store the results such that the results can be used by the computer system and/or another system or method to perform one or more functions for the specimen(s) or another specimen of the same type. For example, that information may be used by the computer system or another system or method for sampling the defects for defect review or other analysis, determining a root cause of the defects, etc.

In the same manner, the computer system and/or other imaging subsystems described herein (e.g., a metrology or defect review subsystem) may be configured to use results of one or more steps described herein to perform other processes on the specimen and/or other specimens of the same type. Such metrology or defect review processes may produce any suitable results known in the art, and the results of such processes may be generated and/or stored by the computer system and/or imaging subsystem as described herein. Those results can then be used in the same manner described herein.

Functions that can be performed using such information also include, but are not limited to, altering a process such as a fabrication process or step that was or will be performed on the inspected specimen or another specimen in a feedback or feedforward manner. For example, the computer system may be configured to determine one or more changes to a process that was performed on a specimen inspected as described herein and/or a process that will be performed on the specimen based on the detected defect(s). The changes to the process may include any suitable changes to one or more parameters of the process. The computer system preferably determines those changes such that the defects can be reduced or prevented on other specimens on which the revised process is performed, the defects can be corrected or eliminated on the specimen in another process performed on the specimen, the defects can be compensated for in another process performed on the specimen, etc. The computer system may determine such changes in any suitable manner known in the art. Such changes may also be determined using results of other processes described herein.

Those changes can then be sent to a semiconductor fabrication system (not shown) or a storage medium (not shown) accessible to the computer system and the semiconductor fabrication system. The semiconductor fabrication system may or may not be part of the system embodiments described herein. For example, the computer system and/or inspection system described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

As described herein, therefore, the embodiments can be used to setup a new process or recipe. The embodiments may also be used to modify an existing process or recipe, whether that is a process or recipe that was used for the specimen or was created for one specimen and is being adapted for another specimen.

Each of the embodiments described above may be combined together into one single embodiment. In other words, unless otherwise noted herein, none of the embodiments are mutually exclusive of any other embodiments.

Another embodiment relates to a computer-implemented method for image reconstruction. The method includes illuminating a specimen with an energy source and generating an image responsive thereto with an imaging subsystem. The specimen has repetitive patterns formed thereon based on a design for semiconductor devices being formed with the specimen. The method also includes separating the image into patch images smaller than the image. When one of the patch images is input into a NN executed by a computer system, the method includes projecting the one of the patch images to a manifold that includes feature vectors learned from training images whose image quality meets or exceeds predetermined criteria. In addition, the method includes reconstructing the one of the patch images from the feature vectors it aligns to on the manifold thereby generating a reconstructed patch image having one or more image qualities better than the input one of the patch images. The separating is performed by the computer system, and the projecting and reconstructing are performed by the NN.

Each of the steps of the method may be performed as described further herein. The method may also include any other step(s) that can be performed by the imaging subsystem, computer system, and NN described herein. In addition, the method described above may be performed by any of the system embodiments described herein.

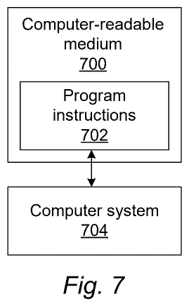

An additional embodiment relates to a non-transitory computer-readable medium storing program instructions executable on a computer system for performing a computer-implemented method for image reconstruction. One such embodiment is shown in FIG. 7. In particular, as shown in FIG. 7, non-transitory computer-readable medium 700 includes program instructions 702 executable on computer system 704. The computer-implemented method may include any step(s) of any method(s) described herein.

Program instructions 702 implementing methods such as those described herein may be stored on computer-readable medium 700. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension), Python, Tensorflow, or other technologies or methodologies, as desired.

Computer system 704 may be configured according to any of the embodiments described herein.

Further modifications and alternative embodiments of various aspects of the invention will be apparent to those skilled in the art in view of this description. For example, methods and systems for image reconstruction are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain attributes of the invention may be utilized independently, all as would be apparent to one skilled in the art after having the benefit of this description of the invention. Changes may be made in the elements described herein without departing from the spirit and scope of the invention as described in the following claims.

1. A system configured for image reconstruction, comprising:
an imaging subsystem configured for illuminating a specimen with an energy source and generating an image responsive thereto, wherein the specimen has repetitive patterns formed thereon based on a design for semiconductor devices being formed with the specimen;
a computer system configured for separating the image into patch images smaller than the image; and
a neural network executed by the computer system and configured for:
when the computer system inputs one of the patch images into the neural network, projecting the one of the patch images to a manifold comprising feature vectors learned from training images whose image quality meets or exceeds predetermined criteria; and
reconstructing the one of the patch images from the feature vectors it aligns to on the manifold thereby generating a reconstructed patch image having one or more image qualities better than the input one of the patch images.

2. The system of claim 1, wherein the manifold is a low dimensional representation of the training images that preserves relationships between data points in the training images.

3. The system of claim 1, wherein the neural network is further configured for learning the feature vectors by unsupervised learning.

4. The system of claim 1, wherein the training images are generated by the imaging subsystem with best known parameters of the imaging subsystem.

5. The system of claim 1, wherein the one or more image qualities of the reconstructed patch image comprise less blur than the input one of the patch images.

6. The system of claim 1, wherein the one or more image qualities of the reconstructed patch image comprise less noise than the input one of the patch images.

7. The system of claim 1, wherein the computer system is further configured for aligning the reconstructed patch image to the design.

8. The system of claim 1, wherein the computer system is further configured for segmenting the reconstructed patch image based on one or more characteristics of the reconstructed patch image.

9. The system of claim 1, wherein the computer system is further configured for automatic calibration of the imaging subsystem based on differences between the reconstructed patch image and the input one of the patch images.

10. The system of claim 1, wherein the computer system is further configured for automatically calibrating the imaging subsystem based on differences between the reconstructed patch image and the input one of the patch images while a process is performed on the specimen with the imaging subsystem.

11. The system of claim 1, wherein the training images are generated for one or more first dies on the specimen, wherein the projecting and reconstructing are performed for additional patch images generated for second dies on the specimen thereby generating corresponding reconstructed additional patch images, and wherein the computer system is further configured for determining information for a mode of the imaging subsystem used for generating the additional patch images based on differences between the additional patch images and their corresponding reconstructed additional patch images.

12. The system of claim 1, wherein the training images are generated for one or more first dies on the specimen, wherein the projecting and reconstructing are performed for additional patch images generated for second dies on the specimen with multiple modes of the imaging subsystem thereby generating corresponding reconstructed additional patch images for different combinations of the second dies and the multiple modes, and wherein the computer system is further configured for selecting one or more of the multiple modes for a process performed on the specimen with the imaging subsystem based on differences between the additional patch images and their corresponding reconstructed additional patch images.

13. The system of claim 1, wherein the training images are generated for one or more first dies on the specimen, wherein the projecting and reconstructing are performed for additional patch images generated for second dies on the specimen thereby generating corresponding reconstructed additional patch images, and wherein the computer system is further configured for determining across specimen variation in a characteristic of the specimen based on differences between the additional patch images and their corresponding reconstructed additional patch images.

14. The system of claim 1, wherein the computer system is further configured for performing single die defect detection for the specimen by identifying differences between the input one of the patch images and the reconstructed patch image and detecting defects in the one of the patch images based on the identified differences.

15. The system of claim 1, wherein the training images are generated by a different imaging subsystem, and wherein the computer subsystem is further configured for adjusting one or more parameters of the imaging subsystem to match the different imaging subsystem based on differences between the input one of the patch images and the reconstructed patch image.

16. The system of claim 1, wherein the energy source is a light source.

17. The system of claim 1, wherein the energy source is an electron beam source.

18. The system of claim 1, wherein the imaging subsystem is further configured as an inspection subsystem.

19. A non-transitory computer-readable medium, storing program instructions executable on a computer system for performing a computer-implemented method for image reconstruction, wherein the computer-implemented method comprises:
illuminating a specimen with an energy source and generating an image responsive thereto with an imaging subsystem, wherein the specimen has repetitive patterns formed thereon based on a design for semiconductor devices being formed with the specimen;
separating the image into patch images smaller than the image;
when one of the patch images is input into a neural network executed by the computer system, projecting the one of the patch images to a manifold comprising feature vectors learned from training images whose image quality meets or exceeds predetermined criteria; and
reconstructing the one of the patch images from the feature vectors it aligns to on the manifold thereby generating a reconstructed patch image having one or more image qualities better than the input one of the patch images, wherein said projecting and said reconstructing are performed by the neural network.

20. A computer-implemented method for image reconstruction, comprising:
illuminating a specimen with an energy source and generating an image responsive thereto with an imaging subsystem, wherein the specimen has repetitive patterns formed thereon based on a design for semiconductor devices being formed with the specimen;
separating the image into patch images smaller than the image;
when one of the patch images is input into a neural network executed by a computer system, projecting the one of the patch images to a manifold comprising feature vectors learned from training images whose image quality meets or exceeds predetermined criteria; and
reconstructing the one of the patch images from the feature vectors it aligns to on the manifold thereby generating a reconstructed patch image having one or more image qualities better than the input one of the patch images, wherein said separating is performed by the computer system, and wherein said projecting and said reconstructing are performed by the neural network.
